(19) United States
(12) Patent Application Publication
(10) Pub. No.: US 2005/0129190 A1
(43) Pub. Date: Jun. 16, 2005

(54) Method, receiving terminal and transmitting terminal for identifying a caller

(76) Inventors: Christoph Euscher, Rhede (DE); Stephan Karger, Hamminkeln (DE); Dirk Langefeld, Langenfeld (DE); Mario Rohle, Braunschweig (DE); Benedikt Rosen, Rees (DE); Malte Schmidt, Bocholt (DE); Rolf Theisen, Bocholt (DE)

Correspondence Address: BELL, BOYD & LLOYD, LLC, P. O. BOX 1135, CHICAGO, IL, 60690-1135, US

(21) Appl. No.: 10/505,331

(22) PCT Filed: Feb. 13, 2003
(86) PCT No.: PCT/DE03/00436

(30) Foreign Application Priority Data
Feb. 21, 2002 (DE) 102 07 291.4

(51) Int. Cl. H04M 11/00; H04M 3/42

(52) U.S. Cl. 379/88.13; 379/218.01

(57) ABSTRACT

A method is provided for identifying a first subscriber of a telecommunication network, a receiving terminal for identifying a first subscriber of a telecommunication network, and a transmitting terminal. According to the inventive method, the identification of the first subscriber is carried out in such a manner that information of at least one type of information for identifying the first subscriber is output to at least one receiving terminal, whereby the output of information of the information type text is excluded on the at least one receiving terminal. This method enables identification capabilities to be integrated in a more diverse manner; in particular, multimedia representations are integrated during the identification of the first subscriber of the telecommunications network.

### BACKGROUND OF THE INVENTION

The present invention relates to a method for identifying a first subscriber of a telecommunications network, a reception terminal for identifying a first subscriber of a telecommunications network and a transmission terminal. It is known that in various telecommunications networks the called subscriber of a telecommunications network is already informed of who the calling subscriber of the telecommunications network is during the connection set-up through a communication on a display unit of the reception terminal which is assigned to him/her. The performance feature of the telecommunications network which is known by the term “caller identification” is offered, for example, within the mobile radio network known as Global System for Mobile Communications GSM.

The communication of the terminal identifier of the calling subscriber to the called subscriber is also offered as a performance feature of the line-bound Euro-ISDN telecommunications network. It is also known by the name Calling Line Identification Presentation CLIP. However, the calling subscriber can suppress the transmission of his/her terminal identifier to the called subscriber within the Euro-ISDN telecommunications network. This performance feature is known by the name Calling Line Identification Restriction CLIR. The call number and the name of the calling subscriber can be presented on the display unit of the called subscriber. Furthermore, there is a display there indicating whether the connection is an internal telephone connection of an enclosed telecommunications network; for example, a company network, or an external telephone connection.

On the other hand, printed visitor's cards for identifying a person to other persons are handed over when people meet.

During the setting up of the telephone connection (i.e., in the signaling phase), a ringing tone generally sounds at the called subscriber of a telecommunications network. The type or form of expression of the ringing tone cannot be influenced by the calling subscriber.

The present invention is therefore directed to a technical solution for identifying a first subscriber of a telecommunications network, which solution entails a greater variety of identification possibilities.

### SUMMARY OF THE INVENTION

According to the present invention, in a method for identifying a first subscriber of a telecommunications network, the first subscriber is identified in such a way that information of at least one information type for identifying the first subscriber is output at at least one reception terminal, with only the output of information of the text information type at the at least one reception terminal being excluded.

One advantage of the present invention is that the calling subscriber of a telecommunications network is identified more quickly by the called subscribers of the telecommunications network if, for example, when the telephone connection is set up, a photo of the calling subscriber is on the display unit of the reception terminals of the called subscribers.

A further advantage of the present invention is that, by virtue of the possibility of connecting information of one or more information types, such as via a video or music, it is possible for the calling subscriber to present himself/herself to the called subscribers in a particularly advantageous and comprehensive fashion. Companies could, for example, make it obligatory for the company logo to appear on the display unit of the reception terminals of the called customers when a telephone connection from their employees is set up.

It is also advantageous for the information of at least one type of information, such as of a multimedia visitor's card, for identifying subscribers of the telecommunications network to be integrated both when setting up a voice connection and during an existing voice connection.

Furthermore, the inclusion of voice or music makes it possible that blind persons to whom a call is to be set up already can recognize the calling subscriber of the telecommunications network during the signaling phase.

It is also advantageous for the calling subscriber of the telecommunications network to assign a priority to the call when the telephone connection is set up. This priority, such as a particular urgency, is indicated to the called subscriber by a particular expression of the ringing tone. The called subscriber then decides whether he/she will accept the call.

Additional features and advantages of the present invention are described in, and will be apparent from, the following Detailed Description of the Invention and the Figures.

### BRIEF DESCRIPTION OF THE FIGURES

FIG. 1 is a schematic view of a telecommunications network in which a first subscriber having a transmission terminal which is operated by him/her sets up or maintains a telephone connection to one or more further subscribers, each of the one or more further subscribers operating a reception terminal.

### DETAILED DESCRIPTION OF THE INVENTION

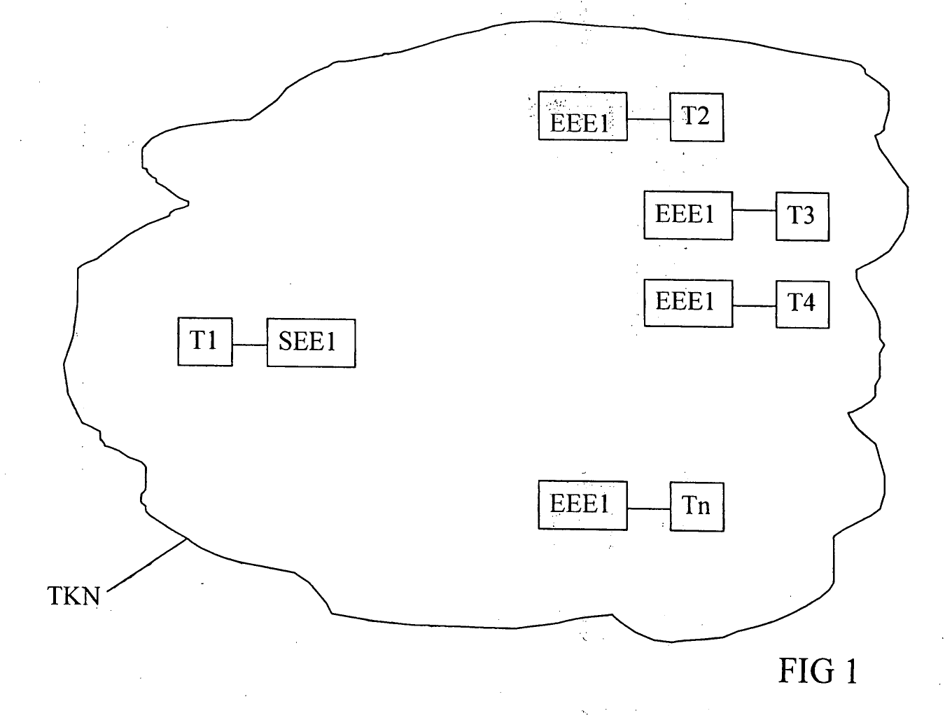

FIG. 1 illustrates an exemplary embodiment of the present invention. Within a telecommunications network TKN there are a number of subscribers T1, . . . , Tn. The subscriber T1 is operating a transmission terminal SEE1. Each of the subscribers T2, . . . , Tn is operating a reception terminal EEE1. The transmission terminal SEE1 and reception terminal EEE1 also may be embodied, for example, as a telephone terminal for line-bound or mobile communication. Furthermore, the transmission terminal SEE1 and the reception terminal EEE1 can be embodied as a computer with a telephone function or as a further terminal device for transmitting and receiving data.

The first subscriber T1 sets up a call to the second subscriber T2 within the telecommunications network TKN. Since the first subscriber T1 has a particularly important and urgent request for the second subscriber T2, the first subscriber T1 selects a high priority for his/her call. This is done by the first subscriber T1 pressing a “priority key” on the transmission terminal SEE1 or selecting the “high priority” feature from a memory of the transmission terminal SEE1 after he/she has input the call number of the second subscriber T2. The first subscriber T1 then presses the start key on the transmission terminal SEE1 so that the call set-up starts. The fact that the call has a high priority for the first subscriber T1 is indicated to the second subscriber T2 by the type or expression of the ringing tone during the signaling phase. As a result, in the case of this call the ringing tone is expressed as a SOS tone. The called second subscriber T2 can take into account the expression of the ringing tone in such a way that he/she accepts the call or records a message on an answering machine which is connected to the reception terminal EEE1.

The first subscriber T1, in turn sets up a call to the second subscriber T2. The first subscriber Ti would like the second subscriber T2 to be able to identify him/her unambiguously during the setting up of the connection. The first subscriber T1 selects a photo of the first subscriber T1 from the memory of the transmission terminal SEE1, includes this photo in the call set-up after inputting the call number of the second subscriber T2 and triggers the setting up of the connection to the second subscriber T2 by pressing the start key on the transmission terminal SEE 1. The photo of the first subscriber T1 already appears on a display unit of the reception terminal EEE1 of the second subscriber T2 during the signaling phase. The second subscriber T2 identifies the first subscriber T1 directly from the displayed photo.

The first subscriber T1 has a series of photos stored in the transmission terminal SEE1 for different moods in which he/she could be. The first subscriber T1 has just passed an exam and includes in the call set-up a photo in which he/she looks joyful. The called second subscriber T2 sees the joyful first subscriber T1 on the display unit of the reception terminal EEE1 and can prepare himself/herself for the mood of the first subscriber T1 before he/she accepts the call. If the first subscriber T1 had failed the exam, he/she would have included in the call set-up a photo in which he/she looks sad, and the second subscriber T2 would have been prewarned.

The first subscriber T1 also may include in the call set-up a title of a current piece of music which is stored in the transmission terminal SEE1, other stored images, moving images (videos) or lines of text. If the first subscriber T1 is a colleague in a company, the company logo which is stored in the transmission terminal SEE1 could be included in the call set-up. If the second subscriber T2 is a customer of the company of the first subscriber T1, the second subscriber T2 could unambiguously identify the first subscriber as a colleague of this company by reference to the company logo which appears on a display unit of the reception terminal EEE1 during the signaling phase. The company can present itself to its customers in a particularly advantageous way by including company logos.

The information which is already communicated from the first subscriber T1 to the second subscriber T2 during the setting up of a telephone connection, and which appears on the display unit of the reception terminal EEE1 of the second subscriber T2, can be of different information types. Information types may include, for example, text, audio information types such as music, voice and ringing, and visual information types such as photos, images, graphics, moving images and videos. Text information is composed of alphanumeric characters; that is to say, numbers, letters and special characters. These information types also may be included in the call set-up in combination with one another. For example, when a connection is set up between the first subscriber T1 and the second subscriber T2, a multimedia visitor's card, on which text information, a photo and a music video are integrated, is selected by the first subscriber T1 and is signaled to the second subscriber T2 during the connection set-up. The second subscriber T2 also can be simultaneously presented with the call number of the calling first subscriber T1, a photo of the first subscriber T1 and a ringing tone which is intended to indicate high priority of the call.

If the second subscriber T2 is a blind person, the first subscriber T1 can include a voice message or a piece of music in the call set-up so that the second subscriber T2 already knows who is calling him/her before accepting the call.

The information which may include one or more information types and which is used to identify the first subscriber T1 to the second subscriber T2 is generally stored in a memory of the transmission terminal SEE1 and can be selected in a known fashion; for example, through a selection using keys. This information, however, also can be stored in a memory of a telecommunications network TKN of a telecommunications provider. The first subscriber T1 sets up a connection to the memory of the telecommunications network TKN before a connection to the second subscriber T2 is set up, the first subscriber T1 selects the desired stored information and includes this information in the setting up of the connection to the second subscriber T2.

Furthermore, the information for identifying the first subscriber T1 also can be stored in a memory of the reception terminal EEE1 of the second subscriber T2. If the reception terminal EEE1 recognizes the first subscriber T1 in the signaling phase by reference to his/her call number, the reception terminal EEE1 assigns a photo of the first subscriber T1 to the call number and causes a photo to be displayed on the display unit of the reception terminal EEE1.

Information of one or more information types can be stored at the transmission terminal SEE1 or the reception terminal EEE1 in multimedia telephone directories or can be created and selected by the subscribers T1, . . . , Tn who operate the respective transmission terminal SEE1 and reception terminal EEE1.

It is also possible to include multimedia visitor's cards of the first subscriber T1 in the short message service known as SMS, to transmit them to the second subscriber T2 in order to identify the first subscriber T1 and to display them on the reception terminal EEE1.

Of course, the called second subscriber T2 can also determine which of the information of one or more information types, which is included in order to identify the first subscriber T1 is to be output at the reception terminal EEE1. Thus, he/she can, for example, suppress the outputting of photos on a display unit of the reception terminal EEE1 or limit the outputting of information on the display unit of the reception terminal EEE1 to one information type for example, voice information. The second subscriber T2 can also set the reception terminal EEE1 in such a way that the second subscriber T2 predefines the mode of expression with which incoming calls with high importance are to be signaled. The first subscriber T1, who sets up a call to the second subscriber T2, includes a ringing tone SOS as a high priority character in the call set-up so that the called second subscriber T2 can ensure, by inputs into the reception terminal EEE1, that this call is output with high priority as a permanent ringing tone.

The possibility of including information of one or more information types is not restricted to the phase of the setting up of a telephone connection. It is also possible that, during an already-existing voice connection between the first subscriber T1 and the second subscriber T2, the first subscriber T1 includes a multimedia visitor's card with the identification data of the first subscriber T1 to the second subscriber T2 in the existing voice connection in order to permit the first subscriber T1 to be comprehensively identified by the second subscriber T2.

The method of including information of one or more information types can also be implemented if a voice connection is set up, or already exists, between the first subscriber T1 and a number of further subscribers T2, . . . , Tn.

If a group call to the members of the group, specifically to the number of further subscribers T2, . . . , Tn is set up by a first subscriber T1, information of one or more information types for permitting the first subscriber T1 to be identified by the number of further subscribers T2, . . . , Tn can be included in the call set-up. When there is an existing voice connection (telephone conference) between the first subscriber T1 and a number of further subscribers T2, . . . , Tn, the first subscriber T1 can include a multimedia visitor's card in the existing voice connection to the number of further subscribers T2, . . . , Tn. The subscriber T1 can determine whether he/she communicates the multimedia visitor's card to all the other subscribers T2, . . . , Tn or only to selected further subscribers; for example, the further subscribers T2 and T3. Both the calling first subscriber T1 and the called number of further subscribers T2, . . . , Tn have the possibility of communicating a multimedia visitor's card to any other desired subscribers T1, . . . , Tn during an existing voice connection.

Furthermore, the first subscriber T1 can define which information of one or more information types for identifying the first subscriber T1 is to be communicated to individual further subscribers T2, . . . , Tn which are participating in an existing voice connection. If there is a voice connection between the subscribers T1, T2, T3 and T4, the first subscriber T1 can communicate a multimedia visitor's card to the second subscriber T2, a ringing tone to the third subscriber T3 and a music video to the fourth subscriber T4.

The present invention thus permits varied and comprehensive inclusion of information of one or more information types for identifying subscribers T1, . . . , Tn of a telecommunications network TKN into calls which are to be set up and into existing voice connections. In this way, the present invention enriches the communication between parties to a call within a telecommunications network TKN.

Although the present invention has been described with reference to specific embodiments, those of skill in the art will recognize that changes may be made thereto without departing from the spirit and scope of the present invention as set forth in the hereafter appended claims.

1-19. (canceled)

20. A method for identifying a first subscriber of a telecommunications network, the method comprising:
outputting information of at least one information type for identifying the first subscriber at at least one reception terminal; and
providing that the information of at least one information type exclude information of a text information type.

21. A method for identifying a first subscriber of a telecommunications network as claimed in claim 20, the method further comprising storing the information of at least one information type in a memory of the telecommunications network.

22. A method for identifying a first subscriber of a telecommunications network as claimed in claim 20, the method further comprising storing the information of at least one information type at the at least one reception terminal.

23. A method for identifying a first subscribe of a telecommunications network as claimed in claim 20, the method further comprising storing the information of at least one information type at a transmission terminal of the first subscriber.

24. A method for identifying a first subscriber of a telecommunications network as claimed in claim 20, wherein the information of at least one information type is at least one of audible information and visual information.

25. A method for identifying a first subscriber of a telecommunications network as claimed in claim 20, wherein the information of at least one information type for identifying the first subscriber is output upon setting up of a voice connection between the first subscriber and at least one further subscriber of the telecommunications network respectively operating the at least one reception terminal.

26. A method for identifying a first subscriber of a telecommunications network as claimed in claim 25, wherein the first subscriber is identified via a voice message output at the at least one reception terminal.

27. A method for identifying a first subscriber of a telecommunications network as claimed in claim 25, wherein the first subscriber is identified via a ringing tone output at the at least one reception terminal.

28. A method for identifying a first subscriber of a telecommunications network as claimed in claim 27, wherein the ringing tone output at the at least one reception terminal may be expressed in different ways as a function of call priority.

29. A method for identifying a first subscriber of a telecommunications network as claimed in claim 20, wherein the information of at least one information type for identifying the first subscriber is output at the at least one reception terminal during an existing voice connection between the first subscriber and at least one further subscriber of the telecommunications network respectively operating the at least one reception terminal.

30. A method for identifying a first subscriber of a telecommunications network as claimed in claim 20, wherein the information of at least one information type may be output simultaneously with the information of a text information type.

31. A method for identifying a first subscriber of a telecommunications network as claimed in claim 30, wherein the first subscriber is identified by a multimedia visitor's card output at the at least one reception terminal via a short message service.

32. A method for identifying a first subscriber of a telecommunications network as claimed in claim 20, wherein the outputting of the information of at least one information type at the at least one reception terminal may be restricted via inputs into the at least one reception terminal.

33. A method for identifying a first subscriber of a telecommunications network as claimed in claim 20, wherein the information of at least one information type may be selected by the first subscriber operating in associated transmission terminal.

34. A reception terminal for identifying a first subscriber of a telecommunications network, comprising parts for outputting information of at least one information type for identifying the first subscriber at at least one reception terminal, wherein the information of at least one information type excludes information of a text information type.

35. A reception terminal for identifying a first subscriber of a telecommunications network as claimed in claim 34, further comprising a memory for storing the information of at least one information type.

36. A reception terminal for identifying a first subscriber of a telecommunications network as claimed in claim 34, wherein the information of at least one information type may be output simultaneously with the information of a text information type.

37. A reception terminal for identifying a first subscriber of a telecommunications network as claimed in claim 34, wherein the outputting of the information of at least one information type may be restricted via inputs into the reception terminal.

38. A transmission terminal for transmitting information of at least one information type to at least one reception terminal of a telecommunications network so as to identify a first subscriber operating the transmission terminal, comprising parts for allowing the first subscriber to make inputs into the transmission terminal so as to determine which information of the at least one information type should be transmitted to the at least one reception terminal, with the information of at least one information type excluding information of at text information type.

39. A transmission terminal for transmitting information of at least one information type to at least one reception terminal of a telecommunications network so as to identify a first subscriber operating the transmission terminal as claimed in claim 38, further comprising a memory for storing the information of at least one information type.

40. A transmission terminal for transmitting information of at least one information type to at least one reception terminal of a telecommunications network so as to identify a first subscriber operating the transmission terminal as claimed in claim 38, wherein the information of at least one information type may be transmitted simultaneously with the information of a text information type.

41. A transmission terminal for transmitting information of at least one information type to at least one reception terminal of a telecommunications network so as to identify a first subscriber operating the transmission terminal as claimed in claim 39, wherein the memory is a multimedia telephone directory.
